(19) United States
(12) Patent Application Publication
(10) Pub. No.: US 2010/0295007 A1
(43) Pub. Date: Nov. 25, 2010

(54) SAFETY BARRIERS

(76) Inventor: John Clement Preston, New South Wales (AU)

Correspondence Address: CHAMBLISS, BAHNER & STOPHEL, P.C., 1000 TALLAN BUILDING, TWO UNION SQUARE, CHATTANOOGA, TN, 37402, US

(21) Appl. No.: 12/734,328

(22) PCT Filed: Oct. 24, 2008
(86) PCT No.: PCT/AU2008/001574

§ 371 Date: Aug. 6, 2010

(30) Foreign Application Priority Data
Oct. 26, 2007 (AU) 2007101042
Oct. 26, 2007 (AU) 2007905897
Jan. 16, 2008 (AU) 2008100047
Jan. 16, 2008 (AU) 2008900205
Jul. 9, 2008 (AU) 2008903523

(51) Int. Cl. E04H 17/16; E04H 17/14; B23P 17/04

(52) U.S. Cl. 256/31; 256/24; 29/428

(57) ABSTRACT

The present invention relates to safety barriers, and in particular, for use around the perimeter of building floors during construction of a building. In one form, the present invention provides a safety barrier module for use in erecting a fenced-off zone around the perimeter of a building floor during construction of a building, the safety barrier module including: a barrier panel for inhibiting the passage of workers or objects from the building floor to the ground below; and at least one counterweighted footing block for receiving a support post connected to the barrier panel, the footing block arranged to rest on the building floor and to counteract loads and forces on the barrier panel to support the barrier panel in a substantially upright position relative to the building floor; wherein the barrier panel is geometrically shaped to extend from a predetermined height down to substantially the building floor level.

### FIELD OF THE INVENTION

The present invention relates to safety barriers. In particular, the invention was conceived for use around the perimeter of building floors during construction of a building.

### BACKGROUND TO THE INVENTION

Safety barriers find use in varied applications where an open space is to be fenced-off or access to and from restricted or unsafe areas is to be prevented. In the building industry, it is known to erect safety barriers around the perimeter of floors of a multi-story building during construction in order to protect workers and objects from falling to the ground below, thereby averting dangerous and hazardous situations.

Such safety barriers typically include a plurality of fencing modules or panels which are temporarily bolted or clamped around the perimeter of each floor of the building. These modules include a panel section which sits substantially perpendicular to the floor of the building, fastened between support poles using bolts or clamps. The poles themselves have a foot flange or similar which is bolted or otherwise permanently clamped to the concrete floors of the building.

Bolting the fences to the floors involves significant labour, and is time consuming, as it is necessary to drill into the concrete floor of the building, and then position the fences in the desired locations and apply the bolts. Further, if access is required to the perimeter of the building floor by a worker, a fence section must be removed and replaced, which requires removal of the bolts, and then further drilling into the concrete floor. This process is again time consuming, involves significant labour, and is thus expensive.

Clamping the fence sections to the floors also involves substantial labour and time. It also creates a potentially hazardous situation for workers since they will be located adjacent the edge of the building when applying the clamps to the perimeter edge of the floor and installing the fences.

Given the time and labour involved in erecting bolted or clamped fences, it has been known for workers to attempt to install such fences hastily and incorrectly, by not applying all of the required bolts for example, and/or incorrectly drilling the concrete floor, and/or incorrectly installing the concrete bolt, resulting in a faulty installation and causing a potentially dangerous situation.

In light of the above, it is desirable to provide a safety barrier which is less time consuming to construct and/or install and which still ensures safety to persons working on a building site above ground floor level.

### SUMMARY OF THE INVENTION

In one aspect, the present invention provides a safety barrier module for use in erecting a fenced-off zone around the perimeter of a building floor during construction of a building, the safety barrier module including: a barrier panel for inhibiting the passage of workers or objects from the building floor to the ground below; and at least one counterweighted footing block for receiving a support post connected to the barrier panel, the footing block arranged to rest on the building floor and to counteract loads and forces on the barrier panel to support the barrier panel in a substantially upright position relative to the building floor; wherein the barrier panel is geometrically shaped to extend from a predetermined height down to substantially the building floor level.

In one form, the barrier panel includes: a first rectangular panel section of defined width, the first panel section being located so as to extend from the predetermined height down to a height above the counterweighted footing block; and a kickboard section of a width smaller than the first panel section and extending from the first panel section down to substantially the building floor level, thereby providing the barrier panel with at least one inward stepped recess for accommodating the footing block. Compared with traditional barrier panels, which are generally rectangular in plan view, barrier panels according to forms of the invention would have corner “cut outs” in the lower edge to provide inward stepped recesses at both widthward sides of the barrier panel which will accommodate the footing blocks employed to anchor the support posts of the safety barrier modules in their upright position.

The kickboard section may include attachment means for removably attaching the kickboard section to the first panel section. Subdividing of the panel section into two separate portions, where the lower portion is removable, allows limited access to the other side of the safety barrier module without needing to remove the entire module. The removable second portion also allows the safety barrier module to be implemented in other areas and for other uses which may not require a full-length panel section, for example crowd control or areas on the ground where small objects falling through the barrier is not of particular concern, or on uneven ground.

Alternatively, the kickboard section may be integral with the first panel section, for ease in manufacture.

In another form, when in position on a building floor, the length of the footing block extends across the plane of the barrier panel, and the width of the footing block is at least partially accommodated within the inward stepped recess, allowing a sturdy and secure structure.

In one embodiment, the first panel section is formed of a first wirelike mesh material, the first wirelike mesh material having a first spacing distance between adjacent wires, and the kickboard section is formed of a second wirelike mesh material, the second wirelike mesh material having a second spacing distance between adjacent wires, wherein the second spacing distance is less than the first spacing distance for at least some of said adjacent wires.

With regard to the footing block, there may be at least one hole formed therein for receiving the support post. Advantageously, the footing block may include a tubular insert in the at least one hole, for strengthening and protecting the interior surface of said hole. In one form, the tubular insert may include a hollow steel tube.

The safety barrier module preferably further includes at least one strengthening post extending between the footing block and the barrier panel for additional strength for the safety barrier module. In one form, the strengthening post includes a substantially upright portion at its lower end and a bent portion at its upper end to connect to the barrier panel.

In an advantageous form, the safety barrier module, which includes a barrier panel, being the first barrier panel, is adapted to receive a second barrier panel upwards of the first barrier panel, to increase the height of the module. More advantageously, the first and second barrier panels are adapted to be arranged in a plurality of orientations. Where two panel sections are used, a first strengthening post may extend between the support element and the first panel section, and a second strengthening post may extend between the support element and the second panel section.

In a second aspect, the present invention provides a safety barrier for use in erecting a fenced-off zone around the perimeter of a building floor during construction of a building, the safety barrier including a plurality of safety barrier modules as defined above arranged adjacent each other to provide minimal space between each module, thereby forming a substantially continuous barrier. Preferably, each module shares at least one footing block with an adjacent module to minimise the number of footing blocks required and further minimise the space between each module.

Preferably, each module is connected to the adjacent module by a clamp member, which adds further strength and stability to the barrier.

In a third aspect, the present invention provides a kickboard for attaching to a safety barrier module for use around the perimeter of a building floor during construction of a building, wherein the safety barrier module includes a barrier panel for inhibiting the passage of workers or objects from the building floor to the ground below, and at least one counterweighted footing block for receiving a support post connected to the barrier panel, the footing block arranged to rest on the building floor and to counteract loads and forces on the barrier panel to support the barrier panel in a substantially upright position relative to the building floor, wherein the barrier panel extends from a predetermined height down to a height above the building floor level, the kickboard including: a geometrically shaped panel member arranged to extend from the barrier panel down to substantially the building floor level; and attachment means for removably attaching the panel member to the barrier panel.

In a fourth aspect, the present invention provides a method for securing a building floor during construction of a building, the method including the steps of: providing a plurality of safety barrier modules as defined above; and erecting the plurality of safety barrier modules to follow at least a part of the perimeter of the building floor such that adjacent barrier panels of the safety barrier modules exhibit minimal space between the barrier panels to form a substantially continuous barrier.

In one form, the step of erecting the plurality of safety barrier modules around the perimeter of the building floor includes the steps of: positioning a plurality of the footing blocks on the surface of the building floor, and connecting the barrier panels to the positioned footing blocks. The footing blocks are merely positioned on the surface of the building floor, avoiding the need for bolting or clamping to secure the barrier.

In a fifth aspect, there is provided a barrier panel, preferably for use in erecting a fenced-off zone around the perimeter of a building floor during construction of a building, the barrier panel including: a first panel section formed of a first wirelike mesh material, the first wirelike mesh material having a first spacing distance between adjacent wires; and a second panel section formed of a second wirelike mesh material, the second wirelike mesh material having a second spacing distance between adjacent wires; wherein the second spacing distance is less than the first spacing distance for at least some of the adjacent wires.

To form a kickboard section for the barrier panel, the second panel section is preferably located adjacent the building floor, and the first panel section is located above the second panel section relative to the building floor.

In a preferred form, the first and second wirelike mesh materials include a plurality of substantially vertical and substantially horizontal wires. Wirelike mesh materials having horizontal and vertical wires are simple and cost effective to manufacture.

In one form, the second spacing distance is less than the first spacing distance for the respective substantially horizontal wires. The first and second spacing distance between the substantially vertical wires may be substantially equal along the entire width of the barrier panel, and the substantially vertical wires of the second wire mesh material may be integral with, and an extension of, the substantially vertical wires of the first wirelike mesh material.

Preferably, the first spacing distance between the adjacent substantially horizontal wires is in the range of 30 mm to 80 mm, more preferably 50 mm, and the second spacing distance between the adjacent substantially horizontal wires is in the range of 3 mm to 29 mm, more preferably 10 mm.

In one embodiment, the width of the second panel section is less than the width of the first panel section, to accommodate a footing block. This may include a recess cut out of each end of the second panel section.

In a sixth form, the present invention provides a method for forming a barrier panel for use in erecting a fenced-off zone around the perimeter of a building floor during construction of a building, the method including at least the steps of: forming a wirelike mesh panel sheet, the mesh panel sheet including a first panel section having a first spacing distance between adjacent wires, and a second panel section having a second spacing distance between adjacent wires, wherein the second spacing distance is less than said first spacing distance for at least some of the adjacent wires.

In one form, the method further includes the steps of: cutting the mesh panel sheet to a desired length; and forming inward stepped recesses at each end of the second panel section, resulting in the length of the second panel section being less than the width of the first panel section.

Preferably, the mesh panel sheet includes a plurality of substantially vertical and substantially horizontal wires. In one embodiment, the mesh panel sheet is formed by laying the horizontal wires on the vertical wires, and welding the horizontal and vertical wires together at a plurality of cross-over points. In another embodiment, the mesh panel sheet is formed by weaving the horizontal wires between the vertical wires.

Forms of the present invention use counterweighted footing blocks as support elements, which are easily positioned on the surface of the building floor, to receive the barrier panel which extends to substantially the building floor surface to prevent, as far as possible, falling of workers or objects from the building floor to the ground below. As the footing blocks themselves act as the counterweight, no bolting or clamping to the floor is required in order to install the safety barrier modules.

In further forms of the present invention, having a smaller width of spacing between adjacent wires at the base of the barrier panel allows the base to act as a kickboard, preventing objects from moving through the barrier and onto the ground below. Being formed of a wire mesh allows the panel to be manufactured simply and cost effectively. The integral “all in one” nature of the panel allows for simple and relatively fast installation, the panel being relatively light in weight, and not requiring additional attachment means to include a kickboard.

The present invention therefore achieves its object by providing a safety barrier which is less time consuming to construct and/or install, while still ensuring safety to persons working on the building site above ground floor level.

An illustrative embodiment of the present invention will now be described with reference to the accompanying figures. Further features and advantages of the invention will also become apparent from the accompanying description.

### BRIEF DESCRIPTION OF THE DRAWINGS

FIG. 1 shows a plurality of safety barrier modules according to one embodiment of the present invention arranged around the perimeter of a building floor;

FIG. 2a is a front elevational view of one safety barrier module according to an embodiment of the present invention;

FIG. 2b is a side elevational view of the safety barrier module of FIG. 2a;

FIG. 3 is a perspective view of the safety barrier module of FIG. 2a;

FIG. 4 is a perspective view of a kickboard section for attaching to a safety barrier module in accordance with one embodiment;

FIG. 5 is a perspective view of a safety barrier module according to a second embodiment of the present invention;

FIG. 6 is a perspective view of a safety barrier module according to a third embodiment of the present invention;

FIG. 7 shows another perspective view of the safety barrier module of FIG. 6;

FIG. 8 shows a perspective view of two safety barrier modules as shown in FIG. 6 arranged adjacent each other;

FIG. 9 shows a perspective view of the safety barrier module of FIG. 6 with additional strengthening post;

FIG. 10 shows a perspective view of two safety barrier modules as shown in FIG. 9 arranged adjacent each other;

FIG. 11 shows a perspective view of the safety barrier module as shown FIG. 9 with an additional barrier panel;

FIG. 12 shows a perspective view of two safety barrier modules as shown in FIG. 11 arranged adjacent each other;

FIG. 13 shows a perspective view of the safety barrier module of FIG. 11 with the two barrier panels arranged in a different orientation;

FIG. 14 shows a perspective view of two safety barrier modules of FIG. 13 arranged adjacent each other;

FIG. 15 is a front elevation of a wire mesh barrier panel according to a fourth embodiment of the present invention;

FIG. 16 is a perspective view of the barrier panel of FIG. 15;

FIG. 17 is an end elevation of the barrier panel of FIG. 15;

FIG. 18 is a plan view of the barrier panel of FIG. 15;

FIG. 19 is a front elevation of the barrier panel of FIG. 15 when connected to support posts;

FIG. 20 is a front elevation of a barrier panel according to a fifth embodiment of the present invention;

FIG. 21 is a perspective view of the barrier panel of FIG. 20;

FIG. 22 is a perspective view of a footing block which may be used with the barrier panel shown in any of FIGS. 1 to 21;

FIG. 23 is a sectional view of the footing block of FIG. 22;

FIG. 24 is a plan view of the footing block of FIG. 22;

FIG. 25 is a side elevation of the footing block of FIG. 22;

FIG. 26 is an end elevation of the footing block of FIG. 22;

FIG. 27 is an exploded view of the footing block of FIG. 22.

### DESCRIPTION OF PREFERRED EMBODIMENT

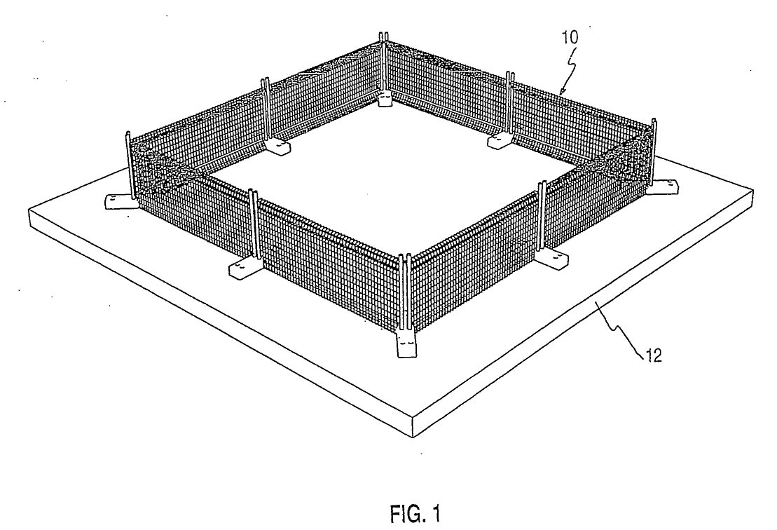

FIG. 1 shows a safety barrier positioned around the perimeter of a building floor 12 including a plurality of safety barrier modules 10.

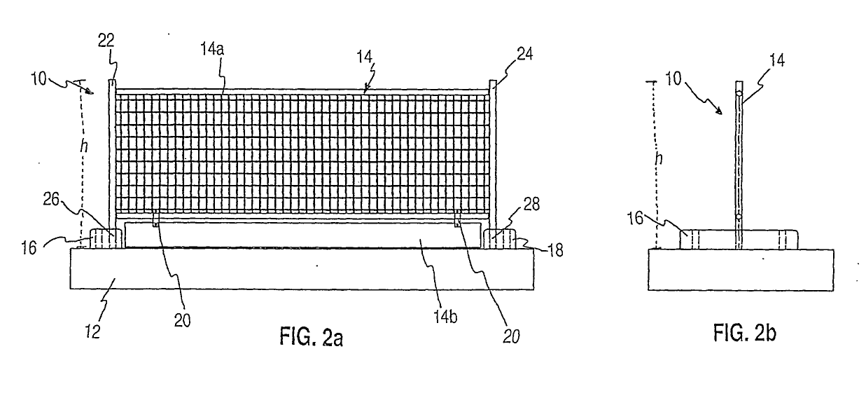

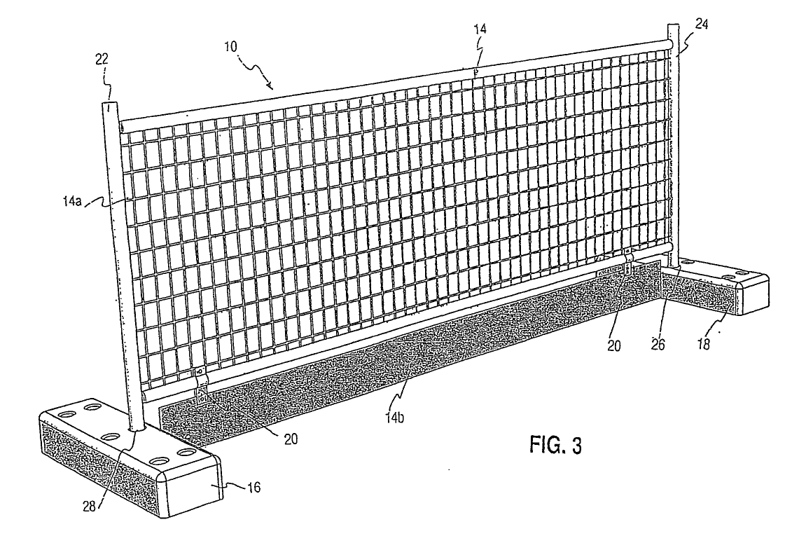

FIGS. 2a, 2b, 3 show one embodiment of a safety barrier module 10, including a barrier panel 14 and support elements 16, 18 taking the form of relatively bulky and heavy, box-like footing blocks resting on the building floor 12. The barrier panel 14 includes a first panel section 14a, a second panel section 14b, connected to two support posts 22, 24.

The barrier panel 14 extends from a predetermined height h above the floor 12 down to substantially the floor 12 to inhibit the passage of workers or objects from the floor 12 to the ground (not shown) below the floor. The predetermined height h will be dependent upon the specific safety and construction rules of the particular jurisdiction. However, it is expected that the height h will be within the range of 0.9 m to 2.5 m.

The first panel section 14a of the barrier panel 14 extends from the predetermined height h down to just above the footing blocks 16, 18. The second panel section 14b extends from just above the footing blocks 16, 18 down to substantially the building floor 12. The second panel section 14b may extend to touch the floor 12, or alternatively may extend down to a small height above the floor 12, however close enough to the floor 12 such that objects cannot accidentally fall from the edge of the floor 12 down to the ground below. The panel section 14 is geometrically shaped to accommodate the support elements 16,18, specifically, the second panel section 14b is of a smaller width to the width of the first panel section 14a.

The second panel section 14b is removably attachable to the first panel section 14a by attachment means 20 taking the form of two metal plates which are configured to fit around the lower edge of the first panel section 14a and bolted together near the upper and lower edges. The attachment means 20 may however take any suitable form, for example bolts extending directly through the first panel section 14a and second panel section 14b.

The first panel section 14a is formed of a wire mesh, which enables a worker to see through the first panel sections 14a if required. The second panel section 14b is formed of a metal sheet of steel. However, any suitable materials could be used for the first and second panel sections, such as a perforated or non-perforated metal sheet or wood panel. Furthermore, the first and second panel sections 14a, 14b could be formed of the same materials, as illustrated in further described embodiments.

The support posts 22, 24 comprise 40 mm in diameter elongate metal tubes, and are used to support the wire mesh therebetween, and also to connect the barrier panel 14 to the footing blocks 16, 18, thereby assisting in supporting the barrier panel 14 substantially upright to enable it to act as a suitable barrier structure. Other sizes and materials for the support posts may be used if desired.

The footing blocks 16, 18 receive the support posts 22, 24 in pre-formed holes 26, 28 therein, as shown in FIG. 3. The depth of the holes 26, 28 and also the height of the footing blocks 16, 18 will be dependent on the material and weight of the barrier panel 14. The dimensions and weight of the footing blocks 16,18 need to be sufficient to counteract to the load of the barrier panel 14 in normal use ie act as a counterweight, and support the barrier panel 14 in a substantially upright position relative to the floor 12. Therefore, the height, length and width of the footing blocks 16,18, and the depth of the holes 16, 18, are not limited to particular dimensions, rather they must be such to support the barrier panel 14 as defined above. It is preferred the barrier panel 14 is sufficiently supported simply by placing the support posts 22, 24 into the holes 26, 28, such that no further bolting or clamping of the barrier panel 14 to the support elements 16, 18 is necessary. This further lessens the time it takes to erect the safety barrier on the building floor.

Preferably, the footing blocks 16, 18 include box-like footing blocks of non-slip recycled PVC plastic and/or with weighted material such as concrete contained therein, such that the weight of each footing block is about 18 kg. The footing blocks may be extrusion moulded to leave a gap where the concrete is inserted therein, or alternatively may be formed in one piece with the concrete (or other suitable weighting material) inserted during construction of the blocks. Alternatively, any other suitably weighted material including entirely concrete, rubber or plastics, or recycled materials, may be used. Each barrier panel may weigh between about 18-24 kg in total, preferably under 20 kg to accord with occupational health and safety requirements. The footing blocks 16,18 have six holes therein, to enable several support posts to be inserted into each footing block 16,18. This allows a substantially continuous line of safety barrier modules surrounding the entire perimeter of the building floor to be erected with each adjacent barrier sharing at least one support element 16, 18. The length of the footing blocks 16, 18 will typically be greater than the width with the length extending across the plane of the barrier panel to enable the footing blocks 16, 18 to counteract the load of the barrier panel 14.

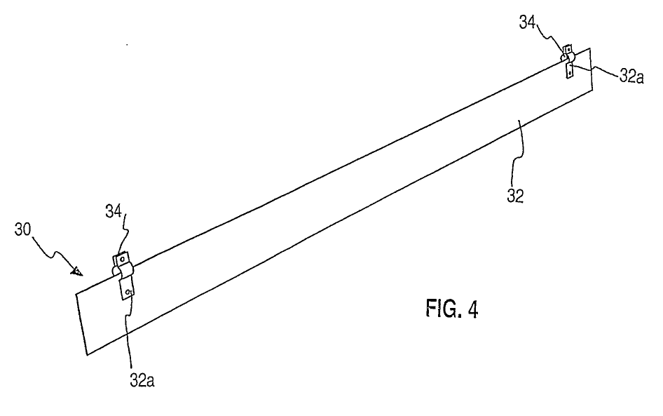

FIG. 4 shows a kickboard 30 for attachment to a barrier panel. The kickboard 30 is removably attachable to a barrier panel of the safety barrier module and adapted to extend from the barrier panel down to substantially the building floor level, to reduce the space between the barrier panel of the safety barrier module and the building floor, and also includes attachment means 34 for removably attaching the kickboard 30 to the barrier panel. In one form, the kickboard 30, in use, is similar to that shown as the second panel section 14a in FIGS. 1, 2a, 2b and 3, however the kickboard 30 may take other forms as desired. The kickboard may be formed of any suitable material, for example wire mesh, a metal sheet, or wood. The attachment means 34 in the embodiment shown includes two metal plates which are configured to fit around the lower edge of the panel section and connected to the kickboard 30, which are bolted together near the upper and lower edges. Other suitable attachment means 34 may be used as desired.

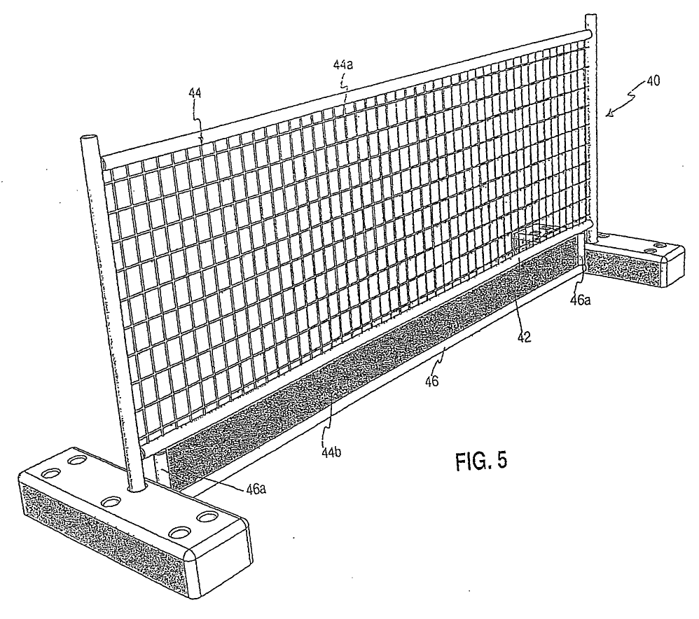

FIG. 5 shows a second embodiment of a safety barrier module 40 with an alternative form of barrier panel 44. The second panel section 44b of the barrier panel 44 includes a rectangular solid metal sheet with elongate tubular sections 46 surrounding three sides. The second panel section 44b is attached to the first panel section 44a by screwing the outer elongate tubular sections 46a to the lower tubular section 42 of the first panel section 44a. Alternatively, the second panel section 44b may be welded to the first panel section 44a to provide a more permanent attachment means.

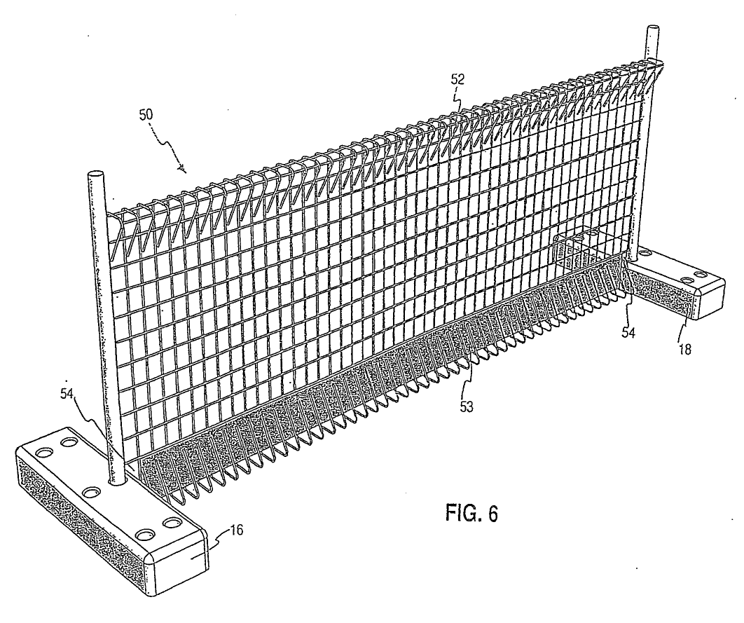

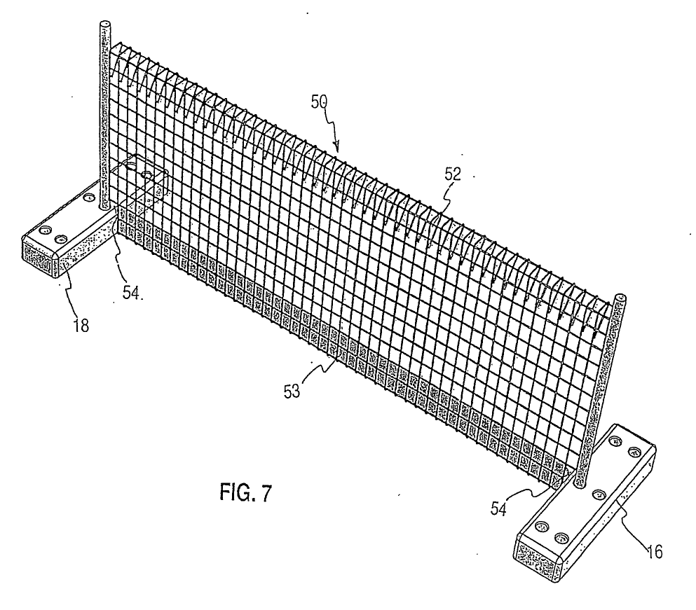

FIGS. 6 and 7 show a third embodiment of a safety barrier module 50, shown from the front and rear of the module 50 respectively, with yet another alternative form of barrier panel 52. In this embodiment, the barrier panel 52 extends from a predetermined height down to substantially the floor (not shown) as one integral wire mesh web or sheet which is geometrically shaped. As such, there is no requirement for two distinct first and second panel sections. Rather, the barrier panel 52 has corner “cut outs”, marked by reference 54, in the lower edge to provide inward stepped recesses to accommodate the footing blocks 56, 58.

The upper and lower edges of the wire mesh barrier panel 52 are bent over, primarily for safety reasons, but also for additional strength. At the lower edge, a solid rectangular metal panel 53 is fixed inside the folded over barrier panel 52 to minimise small articles from passing through the perforations in the barrier panel 52.

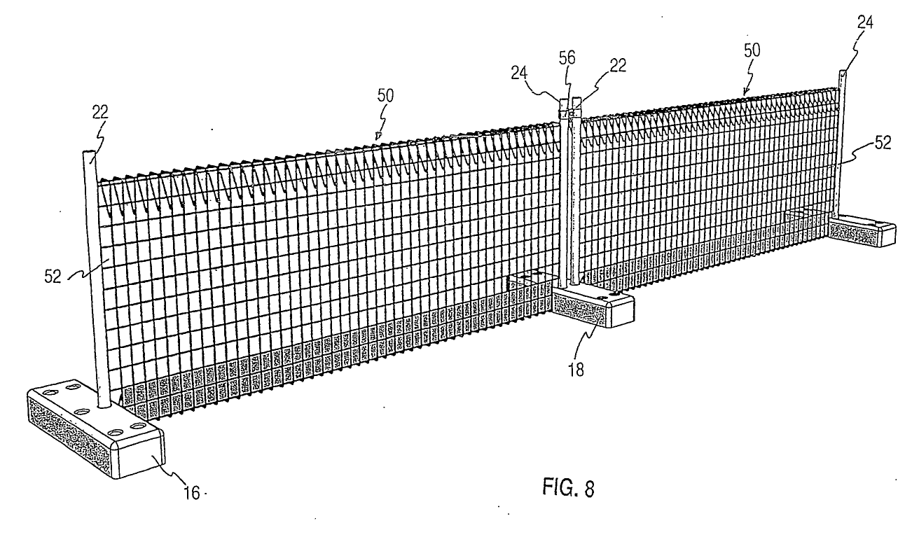

A plurality of safety barrier modules 50 may be used to form a substantially continuous barrier around the entire perimeter of the building floor. A gate (not shown) may be located between two modules 50 if required. As shown in FIG. 8, each adjacent barrier panel 52 will share a footing block 18 with the adjacent barrier panel 52 to minimise the number of footing blocks required. The support posts 22, 24 of adjacent barrier panels 52 are connected by a clamp member 56 located at the upper end of the adjacent support posts 22, 24 for added strength and rigidity. The clamp member 56 comprises an “8” shaped steel clamp which fits around the support posts 22, 24 and is bolted between the posts 22, 24 to secure.

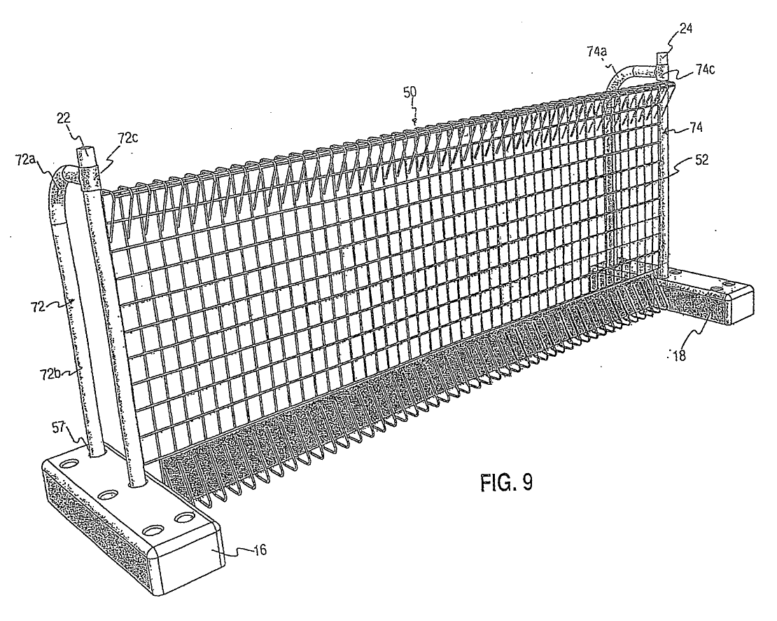

FIG. 9 shows the safety barrier module 50 with an additional strengthening post 72, 74 at each end of the barrier panel 52, which extend between the support posts 22, 24 and the footing blocks 16, 18. The strengthening posts 72, 74 comprise elongate metal tubes similar to the material of the support posts 22, 24, and fit within an outer hole 57 formed in the footing blocks 16, 18. A bent portion 72a, 74a is connected between the upper end of the substantially upright elongate tube 72b, 74b and the support post 22, 24. The upper end of the elongate tube 72b, 74b, is of reduced diameter to the remaining post to allow the lower end of the bent portion 72a, 74a to fit over its end. The upper end of the bent portion 72a, 74a comprises an open cylindrical portion 72c, 74c which fits around the upper end of the respective support post 22, 24.

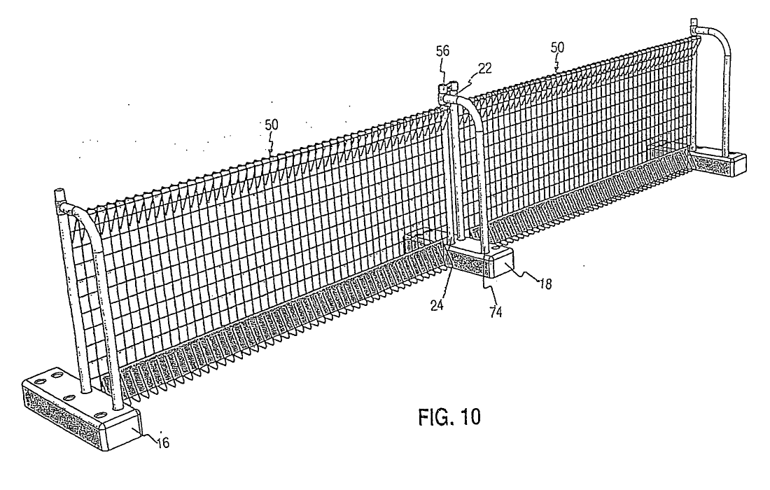

FIG. 10 shows two safety barrier modules 50 arranged adjacent each other to form a substantially continuous barrier, which may be further extended around the perimeter of the building floor. Only one strengthening post 74 is used at each footing block 16,18 between each adjacent safety barrier module, although a second post may be used for additional strength if desired. The adjacent support posts 22, 24 of each safety barrier module are connected via a clamp member 56 as previously described.

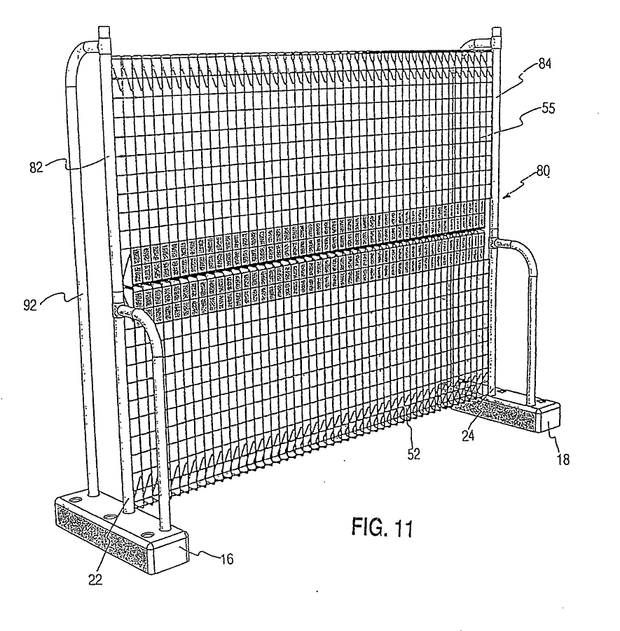

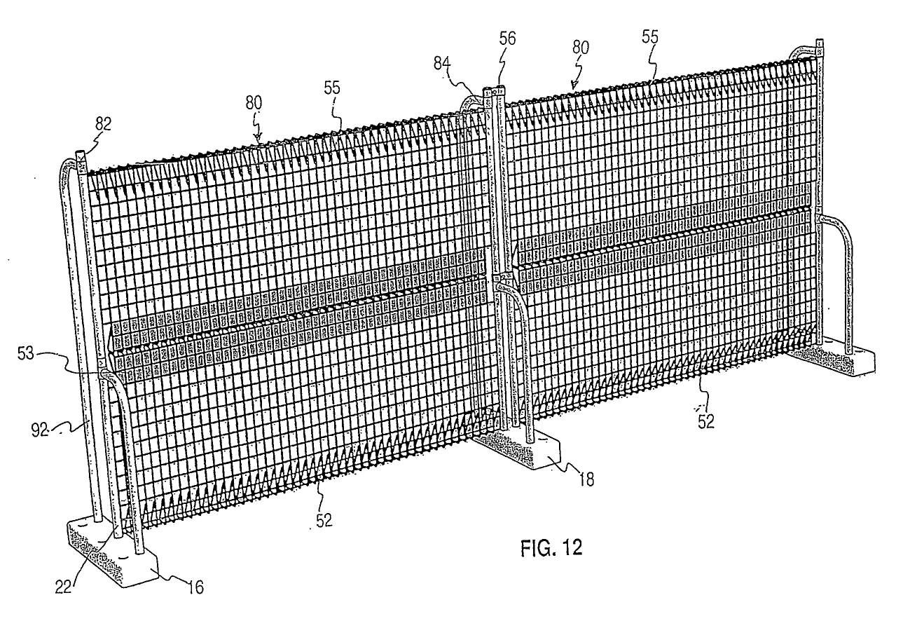

If additional height of the safety barrier module is required, a second barrier panel 55 may be positioned upwards, or above, the first barrier panel 52, as shown in FIGS. 11 and 12. The upper end of the first support posts 22, 24 will have a joint pin with a reduced diameter to join support post 22, 24 to support post 82, 84, or a reduced diameter to that of the lower end of the second support posts 82, 84 to enable the second support posts 82, 84 to be inserted over the end of the first support posts 22, 24. An additional strengthening post 92 may then be used between the footing block 16 and the upper end of the second support post 82 to stabilise the structure.

Various orientations of the barrier panels may be used depending upon need. For example FIGS. 11 and 12 show the lower barrier panel 52 arranged with the solid metal panel 53 at the upper edge of the barrier panel 52, which results in a larger gap at the bottom of the safety barrier module 80 close to the floor. The upper barrier panel 55 is used in the opposite orientation, allowing no gap between the two barrier panels 52, 55.

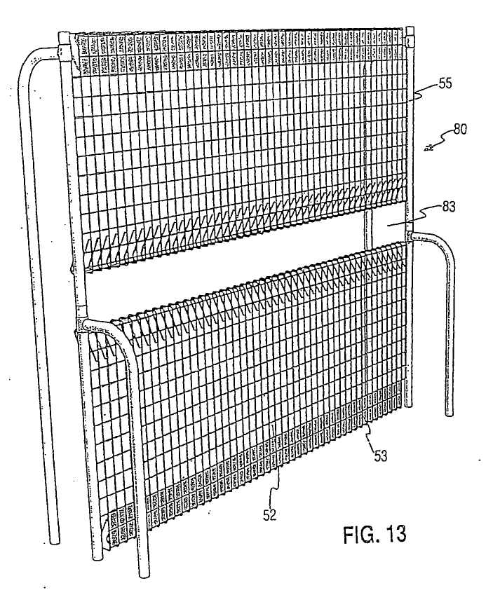

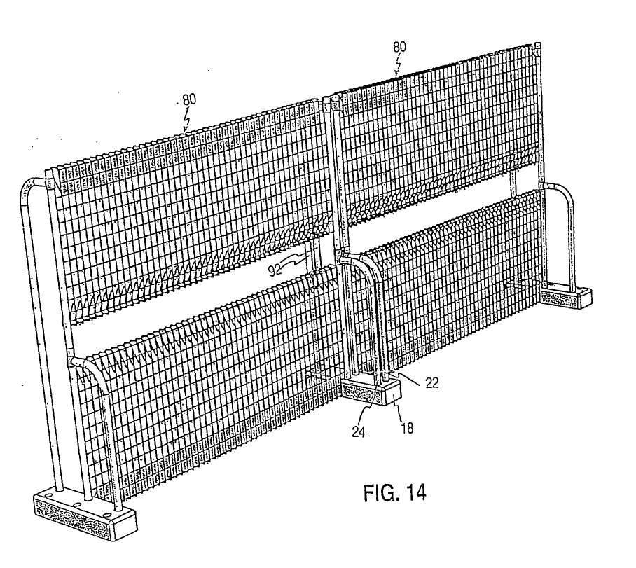

Alternatively, FIGS. 13 and 14 show the lower barrier panel 52 being configured with the solid metal panel 53 at the lower edge of the barrier panel 52, thus extending right to the floor. The upper barrier panel 55 is configured in the opposite orientation, which provides an opening 83 between the two barrier panels 52, 55. Other orientations may also be used as desired.

As shown in FIG. 14, when the additional barrier panel is used, two support posts 22, 24 and two strengthening posts 92 may be desired on the shared footing block 18 for additional strength and rigidity.

In order to erect the safety barrier to secure a building floor during construction of a building, a plurality of safety barrier modules are provided in accordance with one of the embodiments described above. The modules are then erected to follow at least a part of the perimeter of the building floor such that adjacent barrier panels of the modules exhibit minimal space between the barrier panels to form a substantially continuous barrier. As no bolting or clamping of the modules to the floor is required, the erecting of the modules merely requires positioning of the footing blocks on the surface of the building floor, and then connecting the barrier panels to the positioned footing blocks by receiving the support posts in the holes of the footing blocks, or receiving the support posts over the stake of the footing block.

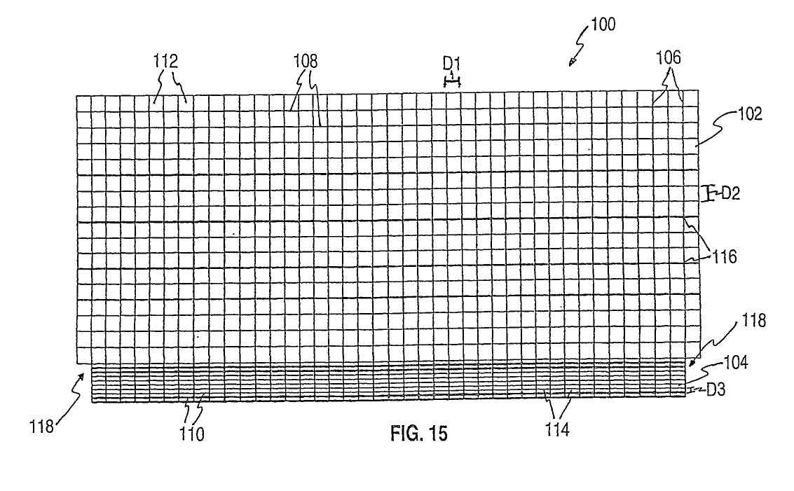

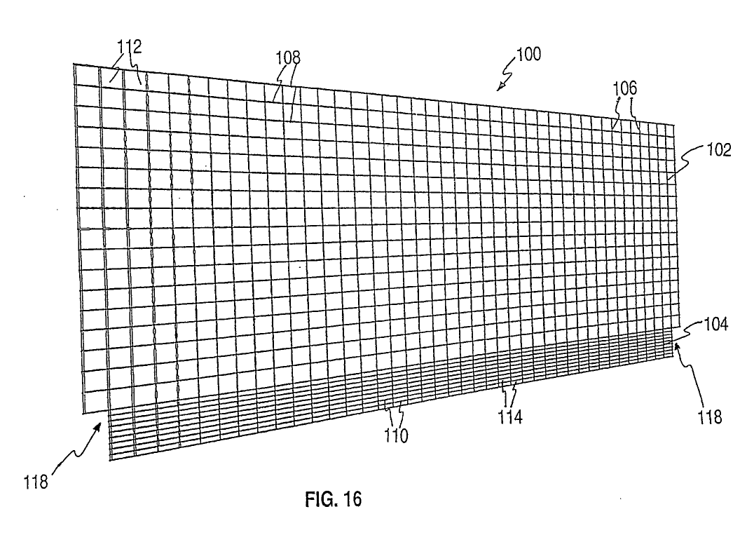

FIGS. 15 to 18 show another embodiment of a barrier panel 100. In this case, there includes a first panel section 102 formed of a first wirelike mesh material, and a second panel section 104 formed of a second wirelike mesh material.

The first and second panel sections 102, 104 include a plurality of parallel substantially vertical and substantially horizontal wires 106, 108 respectively. Each adjacent vertical and horizontal wire is separated by a spacing distance, characterised by D1, D2 and D3 in FIG. 15. The vertical wires 106 in the first panel section 102 include a spacing distance D1, and the horizontal wires 108 include a spacing distance D2. The vertical wires 106 the second panel section 104 also include a spacing distance D1, while the horizontal wires 110 include a spacing distance D3.

It is preferred that in the first panel section 102, both the vertical wires 106 and horizontal wires 108 are spaced approximately 30 mm to 80 mm apart from the adjacent wire, and ideally, 50 mm apart from the adjacent wire. As shown in the figures, a plurality of open squares 112 are then formed, bounded by the adjacent horizontal and vertical wires.

In the second panel section 104, the vertical wires 106 are equally spaced to those in the first panel section 102, being an extension of the wires in the first panel section 102, again between 30 mm to 80 mm, and ideally, 50 mm apart from the adjacent wire. The horizontal wires 110 in the second panel section 104 are however spaced closer together than in the first panel section 102, preferably between 3 mm to 29 mm, and ideally, 10 mm apart from the adjacent wire. As shown in the figures, a plurality of open rectangles 114 are then formed, each having a relatively small area compared to the open squares 112. This construction thereby minimises the possibility of objects passing through or underneath the barrier panel, and negates the need for a separate kickboard as in the prior art, where the second panel section 104 is located adjacent the building floor, and the first panel section 102 is located above the second panel section 104 relative to the building floor.

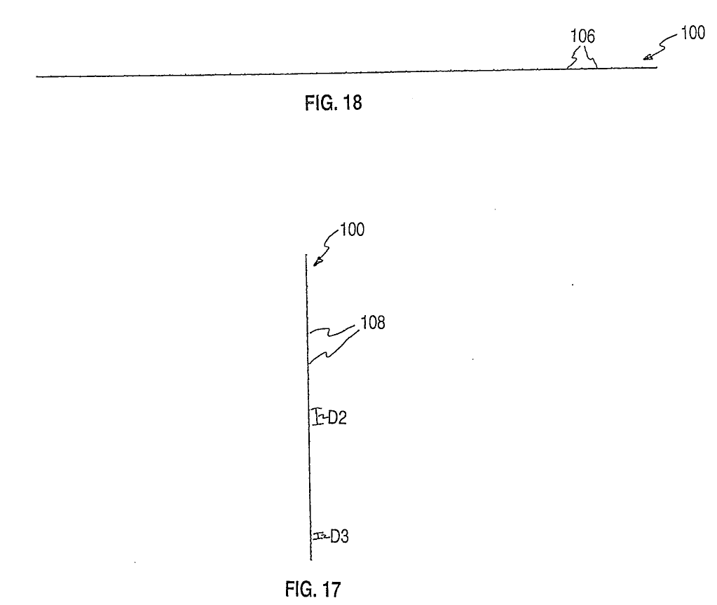

The relative spacing distances between the vertical and horizontal wires of the first and second panel sections 102, 104 can best be seen in the side and end views of FIGS. 17 and 18. In FIG. 17, the horizontal wires 108 of the first panel section 102 are wider spaced (D2) than the horizontal wires 110 in the second panel section 104 (spaced at D3). In FIG. 18, the vertical wires 106 are shown evenly spaced apart along the entire length of the barrier panel 100.

The wires are preferably 3.15 mm diameter steel having a circular cross section, although other suitable materials, shapes and sizes may be used. For example, plastic, rubber or a composite material could be used, and are intended to fall under the terms “wires” and “wirelike”.

The second panel section 104 is preferably between 100 mm to 200 mm in height, thereby comprising approximately 10 horizontal wires 110 forming nine adjacent rectangles 112 in each vertical row. The height and width of the barrier panel 100 (both the first and second panel sections 102, 104) will be dependent upon the specific safety and construction rules of the particular jurisdiction. However, it is expected that the height will be within the range of 0.9 m to 2.5 m, with the first panel section 102 comprising approximately 108 horizontal wires forming 107 adjacent squares. The width of each barrier panel 100 at the first panel section 102 is expected to be approximately 2 m to 3 m for normal use around a building floor. For other uses however, the width and height may vary. For example, the barrier panel 100 may be used in a gate, in which case a much smaller panel may be required. In this case, the width may be less than 1 m, and the height may be about 1 m. The width may be less than the height in some embodiments.

The second panel section 104 is shorter in width than the width of the first panel section 102, having corner “cut outs” at each end thereof, to provide inward stepped recesses 118. The purpose of the corner “cut outs” is again to accommodate counterweighted footing blocks. It is preferred the inward stepped recesses are approximately 50 mm inwards from the end of the barrier panel 100, equating to the width of one spacing distance between adjacent vertical wires 106.

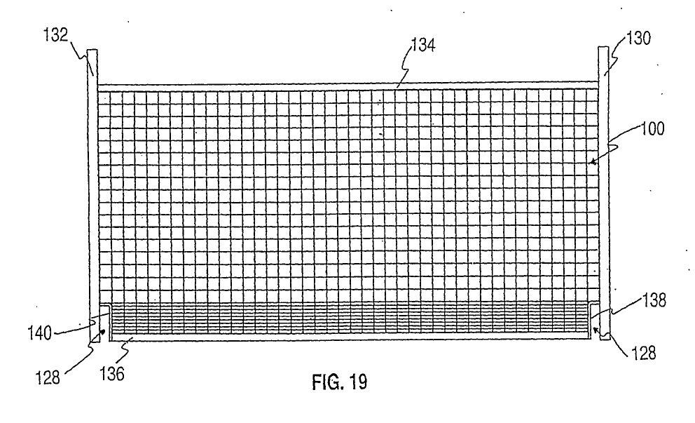

The barrier panel 100 is connected to two support posts 130, 132, as shown in FIG. 19, which comprise 40 mm in diameter elongate metal tubes, and are used to support the wire mesh material of the barrier panel 100 therebetween, and also to connect the barrier panel 100 to the footing blocks (not shown in FIG. 19). Other sizes, shapes and materials for the support posts 130, 132 may be used as desired.

A further two horizontal support bars 134, 136 may be provided along the upper and lower edges of the barrier panel 100, for additional strength and support. These support bars comprise elongate metal tubes of approximately 27 mm diameter. An L-shaped steel member 138, 140 is also provided in each recess 128 for additional strength and support.

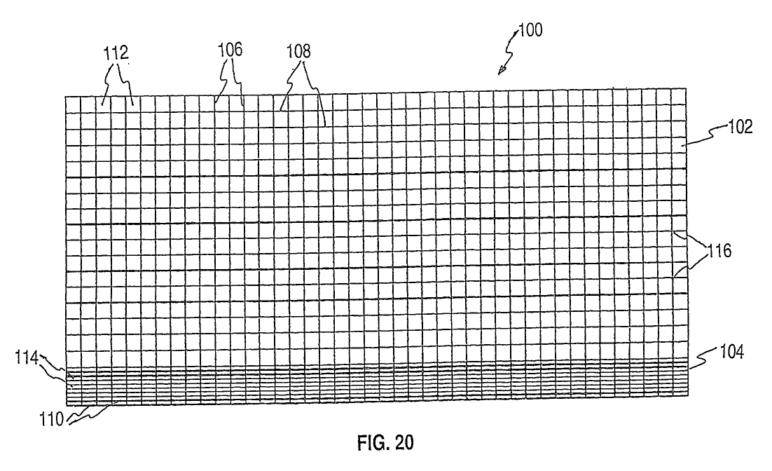

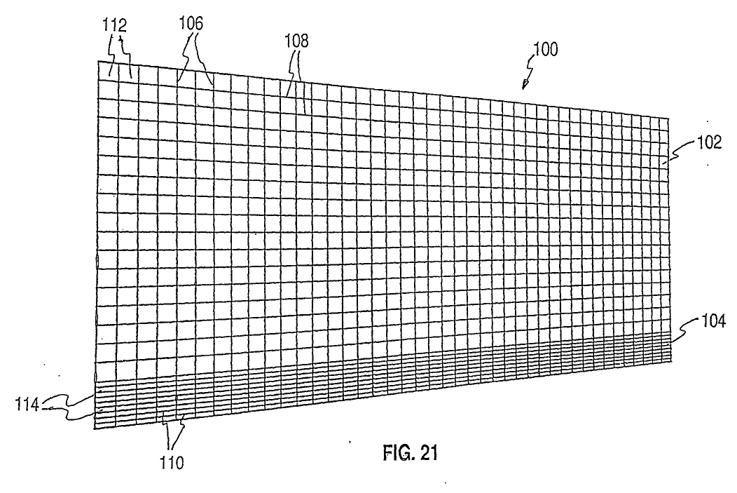

Advantageously, the mesh panel section can be formed as one continuous sheet or web, and in some cases depending upon the weight of the material, may be formed in a roll for storage until ready for use. The horizontal 108 and vertical 106 wires forming the mesh material of the first and second panel sections 102, 104 are joined to each other at each cross over point 116, preferably via welding, although other suitable joining methods, such as a polymer adhesive, may be used. Each vertical wire 106 may be laid out to a workable distance, with the horizontal wires 108, 110 then positioned in the appropriate places and welded (or otherwise connected) to each other. In alternative embodiments, the mesh material may be formed by other suitable methods, for example, each horizontal wire 108, 110 may be weaved in and out of the vertical wires 106. The sheet is then cut to a desired length to form the embodiment shown in FIGS. 20 and 21.

The barrier panel 100 of FIG. 20 can also be used for erecting a fenced-off zone around the perimeter of a building floor during construction of a building, for example using a support element that is a plate-like support foot having an upright connecting stake to fit inside the elongate tubular support post connected to the barrier panel 100, where there is no need to have cut out recesses to accommodate footing blocks. Alternatively, the barrier panel of FIG. 15 or 20 may have many other uses, which also fall within the scope of the present invention. For example, the panel may be used as a guard on scaffolding, where traditionally a solid kickboard is rested against the lower edge of a wire mesh panel. The wire mesh kickboard formed integrally with the wire mesh panel saves on production costs, safety and installation costs. Alternatively, the panel may be used as an architectural decorative panel, such as for buildings for example.

To form the embodiment of FIG. 15 for use with footing blocks, the same rectangular barrier panel as shown in FIG. 20 will first be cut from the sheet to the width of the first panel section 102, after which the lower corners will then be removed from the rectangular panel by cutting the corresponding horizontal and vertical wires, using conventional methods.

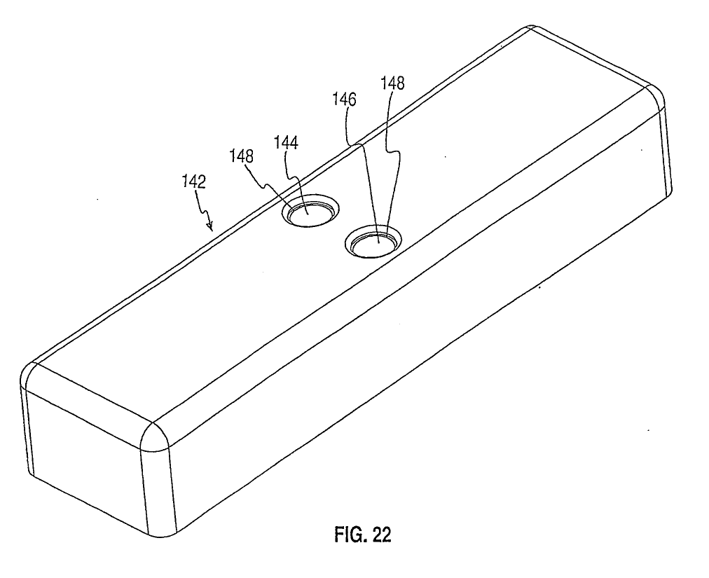

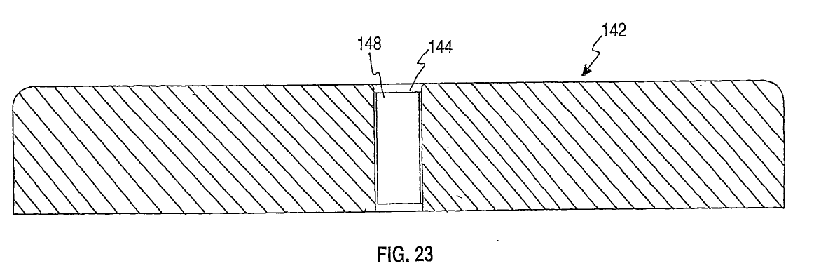

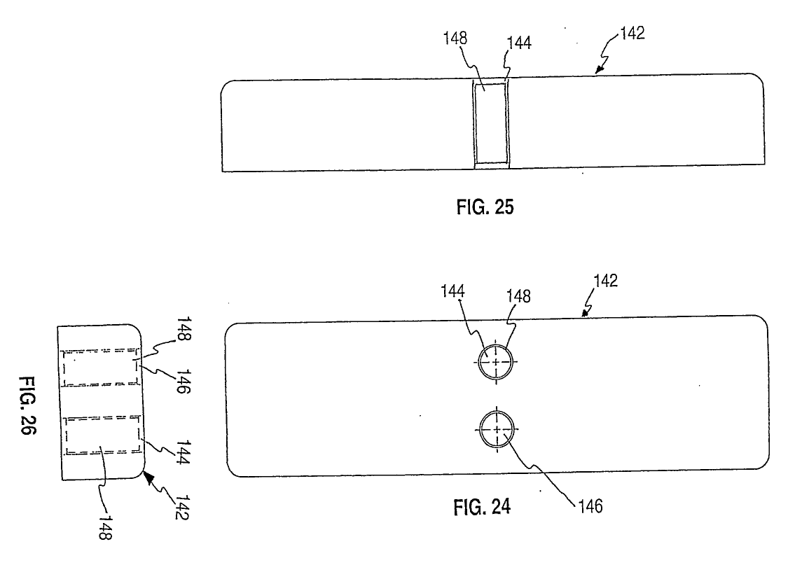

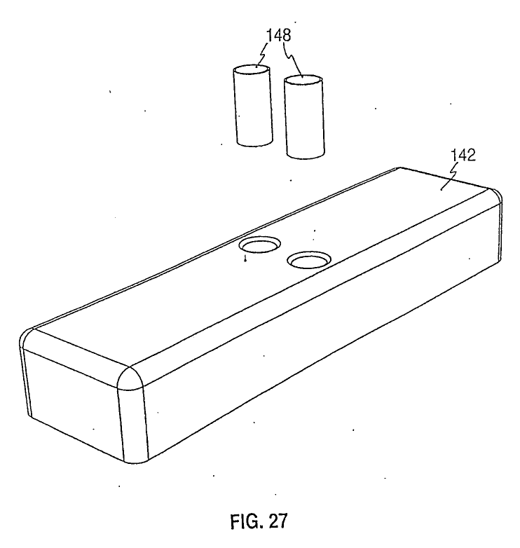

The support posts 130, 132 may then be inserted into respective holes in footing blocks, for example the footing block shown in FIGS. 22 to 27. The footing blocks 142 comprise a rectangular prism shaped structure with sufficient weight to support the barrier panel 100 and support posts 130, 132 in an upright position. The footing block 142 is formed of a concrete and rubber composite, although other suitable materials may be used, for example concrete, plastic or rubber. The footing block 142 may comprise a hollow prism which is filled with sand, water or the like to create the required weight.

The footing block 142 includes two holes 144, 146 extending through the height of the block 142, to receive the support posts 130, 132. In other embodiments, more than two holes may be used, for example one, four or six holes, depending upon the use and purpose of the block 142.

Inserted into each hole 144, 146 is a tubular insert, comprising a hollow tube 148 to strengthen and protect the interior surface of the hole 144, 146, and prevent the hole 144, 146 becoming worn out with constant insertion, movement and removal of the support posts 130, 132. As shown in FIG. 25, the tube 148 extends almost the entire height of the hole 144. The diameter of the tube 148 is such to allow very little movement of a support post 130, 132 inserted into the hole 144, 146, yet having sufficient clearance to allow easy entry of the support post 130, 132. The tube 148 will be of sufficient external diameter to remain in position in the hole 144, 148. The exact sizing may vary depending upon jurisdiction and local standards.

The tube 148 is formed from steel or other durable material, which can withstand insertion and removal of metal support posts 130, 132 without becoming enlarged or losing its shape or strength. The tube 148 may be cast in the footing block 142 during manufacture thereof, or alternatively be inserted after the footing block 142 has been made. It may be preferred to use an adhesive between the interior surface of the hole 144, 146 and the exterior surface of the tube 148 for additional strength and stability.

While the footing block has been illustrated with reference to a circular cross section tubular insert, other shapes may be used where required and appropriate, for example a square or rectangular cross sectional tube. Alternatively, the interior surface of the hole may be strengthened in other ways, for example by coating the surface with a suitable material.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

It will be appreciated that persons skilled in the art could implement the present invention in different ways to the one described above, and variations may be produced without departing from its spirit and scope.

Any discussion of documents, devices, acts or knowledge in this specification is included to explain the context of the invention. It should not be taken as an admission that any of the material forms part of the prior art base or the common general knowledge in the relevant art, in any country, on or before the filing date of the patent application to which the present specification pertains.

1-32. (canceled)

33. A safety barrier module for use in erecting a fenced-off zone around the perimeter of a building floor during construction of a building, the safety barrier module including:
(a) a barrier panel for inhibiting the passage of workers or objects from the building floor to the ground below; and
(b) at least one counterweighted footing block for receiving a support post connected to the barrier panel, the footing block arranged to rest on the building floor and to counteract loads and forces on the barrier panel to support the barrier panel in a substantially upright position relative to the building floor;
wherein the barrier panel is geometrically shaped to include at least one recess for accommodating the footing block to allow the barrier panel to extend from a predetermined height down to substantially the building floor level.

34. A safety barrier module according to claim 33, wherein the barrier panel includes:
(a) a first rectangular panel section of defined width, the first panel section being located so as to extend from the predetermined height down to a height above the counterweighted footing block; and
(b) a kickboard section of a width smaller than the first panel section and extending from the first panel section down to substantially the building floor level,
thereby providing the barrier panel with at least one inward stepped recess for accommodating the footing block.

35. A safety barrier module according to claim 34, wherein when in position on a building floor, the length of the footing block extends across the plane of the barrier panel, and the width of the footing block is at least partially accommodated within the inward stepped recess.

36. A safety barrier module according to claim 34, wherein the first panel section is formed of a first wirelike mesh material, the first wirelike mesh material having a first spacing distance between adjacent wires, and the kickboard section is formed of a second wirelike mesh material, the second wirelike mesh material having a second spacing distance between adjacent wires, wherein the second spacing distance is less than the first spacing distance for at least some of said adjacent wires.

37. A safety barrier module according to claim 36, wherein the first and second wirelike mesh materials include a plurality of substantially vertical and substantially horizontal wires, wherein the second spacing distance is less than the first spacing distance for the respective substantially horizontal wires.

38. A safety barrier module according to claim 37, wherein the first spacing distance between the adjacent substantially horizontal wires is in the range of 30 mm to 80 mm, and the second spacing distance between the adjacent substantially horizontal wires is in the range of 3 mm to 29 mm.

39. A safety barrier module according to claim 37, wherein the first spacing distance between the adjacent substantially horizontal wires is about 50 mm, and the second spacing distance between the adjacent substantially horizontal wires is about 10 mm.

40. A safety barrier module according to claim 1, wherein the footing block includes at least one hole formed therein for receiving the support post, wherein the hole includes a tubular insert for strengthening and protecting the interior surface of said hole.

41. A safety barrier module according to claim 1, wherein the safety barrier module, which includes a barrier panel, being the first barrier panel, is adapted to receive a second barrier panel upwards of the first barrier panel, to increase the height of the module.

42. A kickboard for attaching to a safety barrier module that includes a barrier panel for inhibiting the passage of workers or objects from a building floor to the ground below which extends from a predetermined height down to a height above the building floor, and at least one counterweighted footing block for receiving a support post connected to the barrier panel to support the barrier panel in a substantially upright position relative to the building floor, the kickboard including:
(a) a panel member having a width smaller than the width of the barrier panel to allow the panel member, in use, to extend from the barrier panel down to substantially the building floor level between two counterweighted footing blocks of the safety barrier module; and
(b) attachment means for removably attaching the panel member to the barrier panel;
such that in use the combination of the kickboard and safety barrier module is suitable for use in erecting a fenced-off zone around the perimeter of a building floor during construction of a building.

43. A method for securing a building floor during construction of a building, the method including the steps of:
(a) providing a plurality of safety barrier modules according to claim 33;
(b) erecting the plurality of safety barrier modules to follow at least a part of the perimeter of the building floor such that adjacent barrier panels of the safety barrier modules exhibit minimal space between the barrier panels to form a substantially continuous barrier.

44. A method according to claim 43, wherein the step of erecting the plurality of safety barrier modules around the perimeter of the building floor includes the steps of:
(a) positioning a plurality of the footing blocks on the surface of the building floor, and
(b) connecting the barrier panels to the positioned footing blocks.

45. A barrier panel, for use in erecting a fenced-off zone around the perimeter of a building floor during construction of a building, the barrier panel including:
(a) a first panel section formed of a first wirelike mesh material, said first wirelike mesh material having a first spacing distance between adjacent wires; and
(b) a second panel section formed of a second wirelike mesh material, said second wirelike mesh material having a second spacing distance between adjacent wires;
wherein said second spacing distance is less than the first spacing distance for at least some of the adjacent wires.

46. A barrier panel according to claim 45, wherein the second panel section is located adjacent the building floor, and the first panel section is located above the second panel section relative to the building floor.

47. A barrier panel according to claim 45, wherein the first and second wirelike mesh materials include a plurality of substantially vertical and substantially horizontal wires, wherein the second spacing distance is less than the first spacing distance for the respective substantially horizontal wires.

48. A barrier panel according to claim 47, wherein the first spacing distance between the adjacent substantially horizontal wires is in the range of 30 mm to 80 mm, and the second spacing distance between the adjacent substantially horizontal wires is in the range of 3 mm to 29 mm.

49. A barrier panel according to claim 47, wherein the first spacing distance between the adjacent substantially horizontal wires is about 50 mm, and the second spacing distance between the adjacent substantially horizontal wires is about 10 mm.

50. A barrier panel according to claim 45, further including a recess cut out of each end of the second panel section.

51. A method for forming a barrier panel for use in erecting a fenced-off zone around the perimeter of a building floor during construction of a building, the method including forming a wirelike mesh panel sheet, said mesh panel sheet including a first panel section having a first spacing distance between adjacent wires, and a second panel section having a second spacing distance between adjacent wires, wherein said second spacing distance is less than said first spacing distance for at least some of said adjacent wires.

52. A method according to claim 51, further including the steps of:
(a) cutting said mesh panel sheet to a desired length; and
(b) forming inward stepped recesses at each end of the second panel section, resulting in the length of the second panel section being less than the width of the first panel section.
